(19) United States
(12) Patent Application Publication
(10) Pub. No.: US 2019/0357643 A1
(43) Pub. Date: Nov. 28, 2019

(54) Solar Umbrella

(71) Applicant: MIASOLE PHOTOVOLTAIC TECHNOLOGY CO., LTD., Beijing (CN)

(72) Inventor: Jianwen PAN, Beijing (CN)

(21) Appl. No.: 16/144,017

(22) Filed: Sep. 27, 2018

(30) Foreign Application Priority Data
May 25, 2018 (CN) 201820800591.4

(51) Int. Cl. A45B 25/18; H04R 1/02

(52) U.S. Cl. CPC A45B 25/18; A45B 2200/1018; A45B 2200/1027; H04R 1/028

(57) ABSTRACT

A solar umbrella include: a sun umbrella body, a plurality of photovoltaic modules, a control device and an energy storage device. The sun umbrella body includes a plurality of ribs, umbrella cloth and an umbrella column. The photovoltaic modules are disposed on an outer surface of the umbrella cloth. The control device is electrically connected to the photovoltaic modules and is used for receiving electric energy generated by the photovoltaic modules. The energy storage device is electrically connected to the control device and is used for storing or releasing the electric energy under commands of the control device. The solar umbrella has a sun-shading function and a function of converting solar energy into electric energy simultaneously and can meet more demands of a user.

The present application claims the priority of Chinese patent application No. 201820800591.4, filed on May 25, 2018, titled “solar umbrella”, the entire content of which is incorporated herein by reference.

### TECHNICAL FIELD

The disclosure relates to the field of solar equipment, in particular to a solar umbrella.

### BACKGROUND

An umbrella is a sun-shading tool, umbrella cloth is supported by an umbrella column and ribs to form a shading area, and thus a sun-shading function is achieved by utilizing the shading area.

However, a solar umbrella in the prior art only has a sun-shading or rain-shading function, are single in function, cannot meet the use demands of users and need further improvement.

### SUMMARY

The embodiment of the application provides a solar umbrella with a novel structure.

The solar umbrella includes:

a sun umbrella body, a plurality of photovoltaic modules a control device and an energy storage device,

wherein the sun umbrella body includes a plurality of ribs, an umbrella cloth and an umbrella column;

the photovoltaic modules are disposed on an outer surface of the umbrella cloth;

the control device is electrically connected to the photovoltaic modules and is configured to receive electric energy generated by the photovoltaic modules;

the energy storage device is electrically connected to the control device and is configured to store or release the electric energy under commands received from the control device.

The foregoing description is only an overview of the technical scheme of the application. In order to have a better understanding of the technical means of the application and to implement them according to the content of the description, preferred embodiments of the application are described in detail hereinafter in conjunction with attached drawings.

### BRIEF DESCRIPTION OF THE DRAWINGS

FIG. 1 is a structural schematic diagram of a solar umbrella provided by an embodiment of the application; and

FIG. 2 is a structural schematic diagram of a solar umbrella provided by an embodiment of the application.

### DETAILED DESCRIPTION

For further illustrating the technical means taken for achieving the desired purposes of the application and efficacy of this application, the detailed description, structure, features and efficacy of the solar umbrella of this application are described in detail hereinafter in connection with appended drawings and preferred embodiments. In the following description, different “embodiments” or an “embodiment” is not necessarily the same embodiment. In addition, particular characteristics, structures or features in one or more embodiment may be combined in any suitable form.

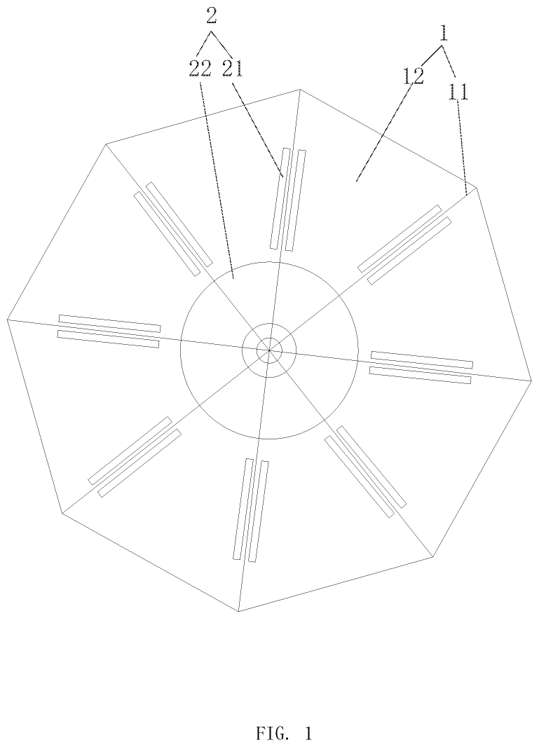

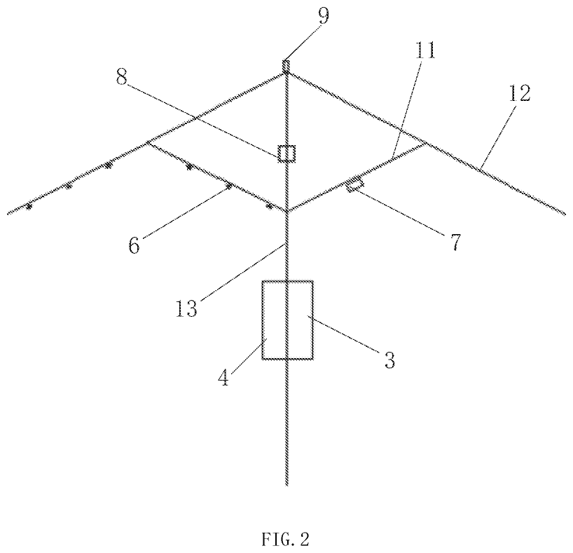

The embodiment of the application provides a solar umbrella, which includes a sun umbrella body 1, photovoltaic modules 2, a control device 3 and energy storage devices 4, as shown in FIGS. 1 and 2. The sun umbrella body 1 includes ribs 11, umbrella cloth 12 and an umbrella column 13; the photovoltaic modules 2 are disposed on the outer surface of the umbrella cloth 12; the first connecting end of the control device 3 is connected with the photovoltaic modules 2; the energy storage devices 4 are connected with the second connecting end of the control device 3.

Particularly, the structure of the sun umbrella in the prior art may be directly used for the sun umbrella body 1, for example, an umbrella body structure which is composed of the ribs 11 and the umbrella cloth 12, may be propped to form a sun-shading and rain-shading space and may be stored through folding, the ribs 11 of which are foldable supporting structures, the umbrella cloth covers the upper surfaces of the ribs 11 and may deform with folding of the ribs 11, the specific structures of the ribs 11 and connecting structures of the umbrella cloth 12 and the ribs 11 are not explained herein, and reference may be obtained from the prior art. In addition, the ribs 11 are preferably made of a metal material having certain strength, the umbrella cloth 12 is preferably made of a rainproof and anti-weathering material, and the structure size of the sun umbrella body 1 composed of the ribs 11 and the umbrella cloth 12 may be set according to the specific use demand.

The photovoltaic modules 2 include first photovoltaic modules 21 and second photovoltaic modules 22 and are modules capable of converting solar energy into electric energy, for example, crystalline-silicon photovoltaic modules or thin-film photovoltaic modules. The shapes of the photovoltaic modules 2 may be set according to the space on the umbrella cloth 12, for example, long strip shapes, rectangular shapes, round shapes or shapes same as the shape of the umbrella cloth. The photovoltaic modules 2 are disposed on the outer surface of the umbrella cloth 12, namely on the surface for keeping out rain and sun of the umbrella cloth 12. The photovoltaic modules 2 may be integrated and may be also composed of multiple single bodies, for example, multiple smaller-sized solar cell pieces connected in series and parallel, and the photovoltaic modules 2 may be disposed on the umbrella cloth 12 by adopting a laminating or sewing manner.

Multiple photovoltaic modules 2 are adopted, and each photovoltaic module 2 is connected with the control device 3.

The control device 3 is a device for controlling the trend of current output by photovoltaic modules, is connected with the photovoltaic modules 2 and adjusts and allocates the electric energy generated by the photovoltaic modules 2 according to specific application scenarios, for example, providing of electric energy for electrical equipment or the energy storage devices 4. For instance, when sunlight is abundant and the current and voltage generated by the photovoltaic modules 2 are higher, the control device 3 can directly supply power by using the electric energy generated by the photovoltaic modules 2 and store the electric energy in the energy storage devices 4 under the condition that power utilization equipment does not consume electric energy; when sunlight is not abundant and the photovoltaic modules 2 do not produce electric energy or cannot produce sufficient electric energy, the control device 3 can also command the energy storage devices 4 to outward output electric energy and supply power for electrical equipment.

The control device 3 can use devices for photovoltaic conversion control in the prior art for reference, including inverters, uninterruptible power supply (UPS) controllers and the like. Direct current generated by the photovoltaic modules 2 is converted into alternating current through an inverter, the alternating current is output, and continuous power supply is achieved through an uninterruptible power supply.

The energy storage devices 4 may be secondary cells which can be charged or discharged for multiple times or cell sets composed of secondary cells, the secondary cells herein may be one of nickel-metal hydride cells, nickel-cadmium cells, lead storage cells and lithium ion cells. The energy storage devices 4 may be a structure disposed with the control device 3 to form a whole and may be also disposed separately, the electric capacity of the energy storage devices 4 may be set according to the photoelectric convertion situation in one day or week, waste caused by setting of too large capacity is avoided, and meanwhile the minimum capacity should not be smaller than the electric quantity for converting solar energy into electric energy of one day.

In the embodiment of the application, the solar umbrella is provided with the photovoltaic modules 2, the control device 3 and the energy storage devices 4, wherein the photovoltaic modules 2 are disposed on the umbrella cloth 12 of the solar umbrella, the solar umbrella can play a sun-shading effect when being propped open, meanwhile the photovoltaic modules disposed on the umbrella cloth 12 can convert light energy into electric energy, the electric energy is stored in the energy storage devices 4 through the control device 3, thus the solar umbrella has a sun-shading function and a function of converting solar energy into electric energy simultaneously and meets the demand for multiple functions of a user. In addition, an external power supply function is added for the solar umbrella by arranging the control device 3, convenience is brought for the user to use electricity; the energy storage devices 4 may be detachably connected, another energy storage device may be installed for charging after one energy storage device is full of electricity, and when the electric energy converted by the photovoltaic modules 2 is insufficient under the situation of insufficient sunlight, the electric energy stored in the energy storage devices 4 can be used for power supply to achieve uninterruptible power supply.

In the preferred embodiment, the photovoltaic modules 2 include multiple first photovoltaic modules 21, wherein the first photovoltaic modules 21 are long-strip-shaped photovoltaic modules and are disposed in the length direction of the ribs, and the first photovoltaic modules 21 are oppositely disposed on two sides of each rib, as shown in FIG. 1. Particularly, the long-strip-shaped first photovoltaic modules 21 need to be disposed on two sides of the ribs and disposed in the length direction of the ribs, the width of the long-strip-shaped first photovoltaic modules 21 needs to be set according to the structure size of the solar umbrella body, namely the width of the long-strip-shaped first photovoltaic modules 21 should be set to first ensure that no larger deformation occurs during rib and umbrella cloth folding.

In the technical scheme of the application, the photovoltaic modules for achieving solar-energy to electric-energy conversion in the solar umbrella are set to be in long-strip shapes, the long-strip-shaped first photovoltaic modules 21 are disposed on the outer surface of the umbrella cloth and located on two sides of the ribs 11 and then cooperate with the control device 3 and the energy storage devices 4 to achieve solar-energy to electric-energy conversion and electric energy storage.

In the solar umbrella provided by the application, the first photovoltaic modules 21 are set to be in long-strip shapes, are disposed on the surface of the umbrella cloth 12 and can be folded and stored with the umbrella cloth 12. Furthermore, the long-strip-shaped first photovoltaic modules 21 are disposed in the length direction of the ribs 11 and located on the outer surface of the umbrella cloth 12 on two sides of the ribs 11, the first photovoltaic modules 21 can move with the ribs by adopting this setting way when the sun umbrella 1 is folded and stored, and the long-strip-shaped photovoltaic modules are parallel to the folding direction of the umbrella cloth 12, so that the first photovoltaic modules 21 located on two sides of the ribs 11 wholly move in the folding direction of the umbrella cloth 12, but folding does not occur in the process of folding the umbrella cloth 12. Thus, the photovoltaic modules are effectively protected, and the situation is avoided that the photovoltaic modules are damaged due to folding, the service life of the photovoltaic modules is prolonged.

In the preferred embodiment, the first photovoltaic modules 21 are laminated on the outer surface of the umbrella cloth 12, as shown in FIG. 1, or the first photovoltaic modules 21 are sewed on the outer surface of the umbrella cloth 12. Particularly, the laminated connection way is that an adhesive material is disposed between the first photovoltaic modules 21 and the umbrella cloth 12 and then is bonded with the first photovoltaic modules 21 and the umbrella cloth 12 through hot-pressing melting to form a whole.

As shown in FIG. 1, in the preferred embodiment, the photovoltaic modules of the solar umbrella provided in the embodiment of the application also include second photovoltaic modules 22 which are annular photovoltaic modules. The annular shape in the embodiment is a circular ring, or an elliptical ring or a polygonal ring, and a circle of annular second photovoltaic modules 22 are disposed at the top of the sun umbrella body 1 to serve as skylight cloth of the umbrella cloth 12; the second photovoltaic modules 22 are connected with the control device 3.

Particularly, due to the fact that the umbrella cloth 12 is formed by splicing multiple triangular or trapezoidal cloth pieces and the portion, located at the top position of the umbrella column 13 of the sun umbrella body 1, of the umbrella cloth 12 is often spliced untight, a piece of annular skylight cloth is disposed at the position, close to the top of the umbrella column 13, of the umbrella cloth, and a complete and seamless shading surface is achieved through matching of the skylight cloth and the umbrella cloth 12. Therefore, photovoltaic modules may be disposed to serve as the skylight cloth of the umbrella cloth 12 in order to increase the area of the photovoltaic modules disposed on the outer surface of the umbrella cloth 12. The second photovoltaic modules 22 herein may be one part of the umbrella cloth 12 and may be also disposed on the surface of the umbrella cloth 12 in the laminated way.

As shown in FIG. 2, in the preferred embodiment, the control device 3 is disposed on the umbrella column 13 of the sun umbrella body 1 and located in the shading area of the umbrella cloth 12.

Particularly, the control device 3 needs to be prevented from being splashed wet by rainwater, so that the control device 3 is preferably disposed in the shading area of the umbrella cloth 12.

Meanwhile, for making the user conveniently control and adjust the control device 3, the control device 3 is preferably disposed on the umbrella column 13 of the sun umbrella body 1, the set height of which preferably conforms to the operating habits of the user, for example, the position 1.4-1.6 m away from the bottom end of the umbrella column 13.

As shown in FIG. 2, in the preferred embodiment, connecting wires for the photovoltaic modules 2 and the control device 3 are disposed along the ribs 11, or the ribs 11 are hollow rods, the connecting wires for the photovoltaic modules 2 and the control device 3 are disposed in the hollow parts of the ribs 11. Furthermore, the umbrella column 13 is a hollow rod, and the connecting wires for the photovoltaic modules 2 and the control device 3 are also disposed in the hollow part of the umbrella column 13. Accordingly, hiding of the connecting wires is achieved, the solar umbrella is visually simple, and inconvenient operation and potential safety hazards caused by external arrangement of the wires are also avoided.

Particularly, wire disorder caused by excessive connecting wires can be avoided by specifically arranging the connecting wires for the photovoltaic modules 2 and the control device 3 in the above way, meanwhile the user or the object held by the user can be prevented from being scraped by or wound by the connecting wires. In addition, the situation does not occur that the ribs 11 are interfered with the connecting wires due to excessive and disordered wires in the process of propping the solar umbrella open.

In the preferred embodiment, the solar umbrella provided by the application also includes a power supply socket which is disposed on the umbrella column 13 of the sun umbrella body 1, and the input end of the power supply socket is connected with the control device 3.

Particularly, the power supply socket may be a commonly-used two-phase socket or three-phase socket or a USB port capable of directly charging electronic equipment. In addition, for making the user conveniently use the power supply socket, the power supply socket is preferably disposed a certain distance away from the ground, for example, the power supply socket is located in the range 0.8-1.6 m away from the bottom end of the umbrella column. Moreover, the power supply socket may be also disposed on the control device 3.

As shown in FIG. 2, in the preferred embodiment, the solar umbrella provided by the application also includes illumination lamps 6 which are connected with the control device 3, disposed along the ribs 11 and shaded by the umbrella cloth 12.

Particularly, the number of the illumination lamps 6 is set according to the specific demand, the illumination lamps 6 are preferably LED lamps for saving electricity and meeting the durable demand, multiple LED lamps are preferably disposed on the ribs 11 at intervals and located below the umbrella cloth 12, and the LED lamps are preferably distributed evenly for achieving attractive appearance and improving the illumination effect.

As shown in FIG. 2, in the preferred embodiment, the solar umbrella provided by the application also includes a spray fan 7 and a loudspeaker box 8, both the spray fan 7 and the loudspeaker box 8 are connected with the control device 3; the spray fan 7 is disposed on the ribs 11 and shaded by the umbrella cloth 12, and a spray air outlet of the spray fan 7 faces the shading area of the umbrella cloth 12; the loudspeaker box 8 is disposed on the umbrella column 13 of the sun umbrella body and shade by the umbrella cloth 12 and is close to the top position of the umbrella column 13.

Particularly, the spray fan 7 can bring cooler experience to the user shaded by the solar umbrella.

The loudspeaker box may be an intelligent loudspeaker box, may be connected with a mobile terminal of the user in a wireless way, is controlled through the mobile terminal, may be also connected with a network in a wireless way and thus plays audios transmitted through the network.

The control device 3 may be also a controller for controlling the work of the spray fan and the loudspeaker box while supplying power for the spray fan and the loudspeaker box, and the specific control way may be set according to the preferences of the user and is not specifically limited in this application.

As shown in FIG. 2, in the preferred embodiment, the solar umbrella provided by the application also includes monitoring equipment 9, the monitoring equipment 9 is connected with the control device 3 and is disposed at the top end of the umbrella column 13 of the solar umbrella body and located on the outer surface of the umbrella cloth. The monitoring equipment may be a camera, a microphone and the like.

Particularly, the monitoring equipment 8 is disposed at the top end of the solar umbrella and can monitor the periphery of the solar umbrella and be directly powered on through the control device 3, and the demand for safety monitoring of the user is met.

The mentioned above are only the preferred embodiments of this application, not for the purpose of limiting the application in any form, and any simple change, equivalent and modification to the above embodiments according to the technical essence of the application should be within the scope of the technical scheme of the application.

I claim:

1. A solar umbrella, comprising
a sun umbrella body, a plurality of photovoltaic modules, a control device and an energy storage device,
wherein the sun umbrella body comprises a plurality of ribs, an umbrella cloth and an umbrella column;
the photovoltaic modules are disposed on an outer surface of the umbrella cloth;
the control device is electrically connected to the photovoltaic modules and is configured to receive electric energy generated by the photovoltaic modules;
the energy storage device is electrically connected to the control device and is configured to store or release the electric energy under commands received from the control device.

2. The solar umbrella according to the claim 1, wherein the photovoltaic modules are disposed on the outer surface of the umbrella cloth in a laminating or sewing manner.

3. The solar umbrella according to the claim 1, wherein the photovoltaic modules comprise first photovoltaic modules disposed on two sides of the ribs in a length direction of the ribs.

4. The solar umbrella according to the claim 2, wherein the photovoltaic modules comprise first photovoltaic modules disposed on two sides of the ribs in the length direction of the ribs.

5. The solar umbrella according to the claim 4, wherein a skylight cloth is disposed in a central area of the umbrella cloth, and the photovoltaic modules further comprise second photovoltaic modules disposed on an outer surface of the skylight cloth.

6. The solar umbrella according to the claim 5, wherein the second photovoltaic modules are annular photovoltaic modules disposed around the umbrella column.

7. The solar umbrella according to the claim 1, wherein the control device is disposed on the umbrella column.

8. The solar umbrella according to the claim 1, wherein the ribs are hollow rods, and connecting wires configured to connecting the photovoltaic modules and the control device are disposed in hollow parts of the ribs.

9. The solar umbrella according to the claim 1, wherein the umbrella column is a hollow rod, and connecting wires configured to connecting the photovoltaic modules and the control device are disposed in a hollow part of the umbrella column.

10. The solar umbrella according to the claim 1, further comprising:
a power supply socket, wherein the power supply socket is disposed on the umbrella column, and an input end of the power supply socket is connected with the control device.

11. The solar umbrella according to the claim 1, further comprising:
a plurality of illumination lamps, wherein the illumination lamps are connected with the control device and disposed along the ribs.

12. The solar umbrella according to the claim 1, further comprising:
a spray fan, wherein the spray fan is connected with the control device and is disposed on the ribs, and a spray air outlet of the spray fan is disposed towards a shading area of the umbrella cloth.

13. The solar umbrella according to the claim 1, further comprising:
a loudspeaker box, wherein the loudspeaker box is connected with the control device;
the loudspeaker box is disposed on the umbrella column of the sun umbrella body.

14. The solar umbrella according to the claim 1, further comprising:
monitoring equipment, wherein the monitoring equipment is connected with the control device and is disposed at a top end of the umbrella column of the sun umbrella body.

15. The solar umbrella according to the claim 1, wherein a skylight cloth is disposed in a central area of the umbrella cloth, and the photovoltaic modules comprise second photovoltaic modules disposed on an outer surface of the skylight cloth.

16. The solar umbrella according to the claim 5, further comprising:
a power supply socket, wherein the power supply socket is disposed on the umbrella column, and an input end of the power supply socket is connected with the control device.

17. The solar umbrella according to the claim 5, further comprising:
illumination lamps, wherein the illumination lamps are connected with the control device and disposed along the ribs.

18. The solar umbrella according to the claim 5, further comprising:
a spray fan, wherein the spray fan is connected with the control device and disposed on the ribs, and a spray air outlet of the spray fan faces a shading area of the umbrella cloth.

19. The solar umbrella according to the claim 5, further comprising:
a loudspeaker box, wherein the loudspeaker box is connected with the control device;
the loudspeaker box is disposed on the umbrella column of the sun umbrella body.

20. The solar umbrella according to the claim 5, further comprising:
monitoring equipment, wherein the monitoring equipment is connected with the control device and disposed at a top end of the umbrella column of the sun umbrella body.
